(19) United States
(12) Patent Application Publication
(10) Pub. No.: US 2004/0174146 A1
(43) Pub. Date: Sep. 9, 2004

(54) Output adjust circuit for a DC-to-DC converter

(76) Inventor: Brooks R. Leman, Santa Clara, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/384,505

(22) Filed: Mar. 7, 2003

(51) Int. Cl. G05F 1/40; G05F 1/44

(52) U.S. Cl. 323/266

(57) ABSTRACT

A system may comprise a DC-to-DC converter, a load coupled to and receiving an operating voltage from the converter and an output adjust circuit coupled to the converter and the load. The output adjust circuit may receive a first voltage from the load, generate a second voltage indicative both of the first voltage and of an offset signal, and provide the second voltage to the converter. The DC-to-DC converter may control the operating voltage using the second voltage.

### BACKGROUND

Active electrical components generally require electrical power to operate. As an example, a computer may include a battery for its power or receive electrical power from an alternating current (AC) wall outlet. Regardless of the power source, the computer's individual electrical components generally require electrical power in a particular form. Typically, that form includes direct current (DC) voltage. The AC wall outlet may supply 120 volts of AC (i.e., time varying) voltage to the computer. The computer may include a power supply which, among other things, may perform the function of converting the incoming 120 VAC power to one or more suitable DC voltages (e.g., 5 VDC, 3.3 VDC, etc.). Even if the computer operates from a battery, which produces DC voltage, the battery's DC voltage may still have to be converted to a different voltage level for the particular needs of the computer's electrical devices.

DC-to-DC converters may be employed to convert a DC voltage from one level to another. Such converters may be used in numerous of applications, not the least of which include computers. DC-to-DC converters typically are fabricated as pre-packaged modules which can, for example, be mated with a circuit board in an electronic system. In general, a DC-to-DC converter receives an input DC voltage and generates an output DC voltage at a predefined voltage level. The converter may include other input pins having signals that enable the converter to maintain its output voltage at the rated level. Such input pins may include “sense” inputs which may be connected to the load to which the converter is connected. The converter may also include a “trim” pin which may be used, with circuitry external to the converter module, to tune the output voltage of the converter to account for voltage losses between the converter and the load connected to the converter. The trim input generally provides a system designer some degree of control over the converter's output voltage.

A manufacturer of DC-to-DC converters may provide trim inputs on its converter modules, but may require the trim inputs to be used differently than for other manufacturer's modules. That is, a particular external circuit may need to be connected to the trim input of one manufacturer's converter, while a different external circuit may need to be connected to the trim input of another manufacturer's converter. The customization required to implement trim inputs of disparate converter modules places a burden on the designer of the system in which the converter is to operate.

### BRIEF SUMMARY

The present disclosure includes methods and systems that may address the problem noted above. In some embodiments, a system may comprise a DC-to-DC converter, a load coupled to and receiving an operating voltage from the converter and an output adjust circuit coupled to the converter and the load. The output adjust circuit may receive a first voltage from the load, generate a second voltage indicative both of the first voltage and of an offset signal, and provide the second voltage to the converter. The DC-to-DC converter may control the operating voltage using the second voltage. As such, the output adjust circuit, which may be usable in conjunction with a wide range of converters, may be used to control the operation of the DC-to-DC converter, thereby avoiding the necessity to have to provide circuitry external to the converter that is customized to the particular design of the converter.

### BRIEF DESCRIPTION OF THE DRAWINGS

For a detailed description of the embodiments of the invention, reference will now be made to the accompanying drawings in which:

FIG. 1 shows a system in which an output adjust circuit may be used in conjunction with a DC-to-DC converter in accordance with exemplary embodiments;

FIG. 2 shows the output adjust circuit in greater detail in accordance with various embodiments of the invention; and

FIG. 3 shows an embodiment usable to generate an offset inject current to be used with the output adjust circuit of FIGS. 1 and 2.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be exemplary of that embodiment, and not intended to intimate that the scope of the disclosure, including the claims, is limited to that embodiment.

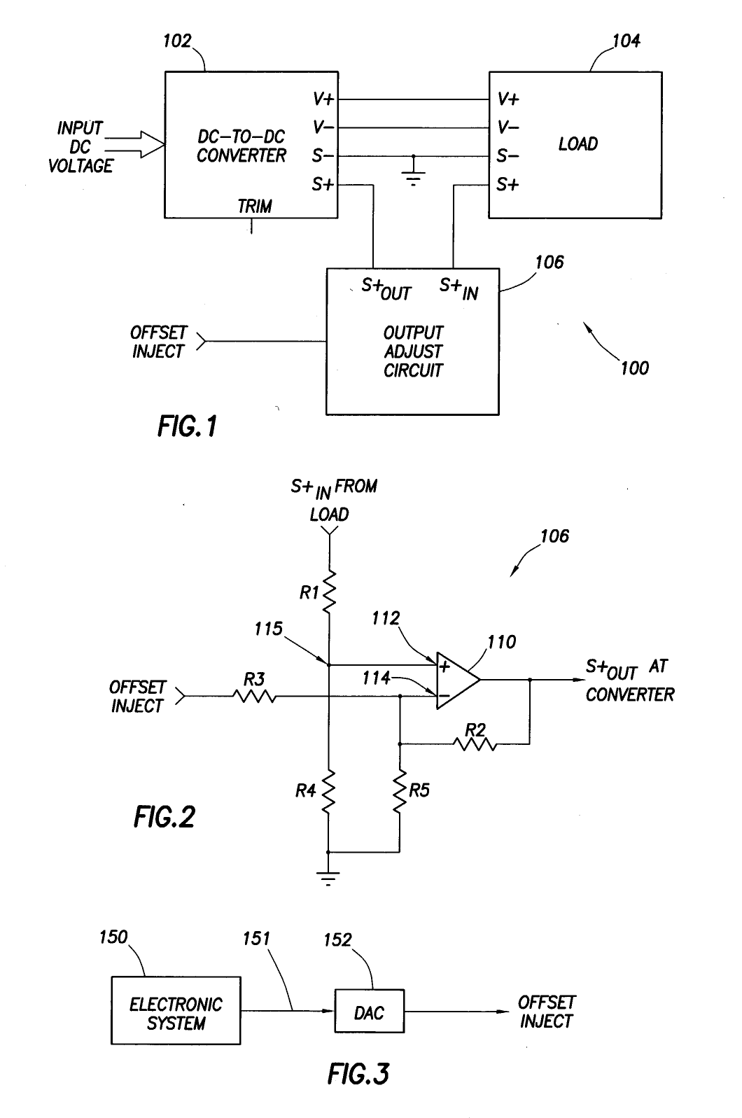

Referring now to FIG. 1, a system 100 is shown as comprising a DC-to-DC converter module 102, a load 104 and an output adjust circuit 106. Although only one each of a converter module 102, load 104 and output adjust circuit 106 is shown in FIG. 1, in other embodiments any number of converters 102, loads 104 and output adjust circuits 106 may be included. In general, the DC-to-DC converter 102 receives an input DC voltage and generates an output DC voltage across the V+ and V− terminals of the converter. The V+ and V− terminals of the converter 102 may be connected to corresponding V+ and V− terminals of the load 104. The load 104 may comprise one or more electrical components such as, and without limitation, a microprocessor in a computer. The load 104 thus may comprise a single component or a plurality of components coupled together to form a functional system.

Both the converter 102 and load 104 may include sense pins S+ and S− as shown in FIG. 1. The S− terminals may be connected together and grounded if desired. The S+ terminal of the load 104 may connect to an S+ᵢₙ input terminal of the output adjust circuit 106. A S+ₒᵤₜ output terminal from the output adjust circuit 106 may connect to the S+ terminal of the converter 102. Further, an offset inject current or voltage may be provided to the output adjust circuit 106. The operation of the output adjust circuit 106 will be explained below.

Referring still to FIG. 1, the sense voltage, S+, from the load 104 generally is provided to the DC-to-DC converter 102 through the output adjust circuit 106. Based on the magnitude of the offset inject current, the output adjust circuit 106 may cause the sense voltage from the load to be altered as provided to the converter 102 via the S+ₒᵤₜ output. The output adjust circuit 106 thus permits the converter's output voltage (across its V+ and V− terminals) to be adjusted as desired based on the offset inject signal. It should be noted that the DC-to-DC converter 102 may include a trim terminal (TRIM), or equivalent, but, as explained below, the TRIM input can be used, but need not be used if desired.

In some embodiments, such as in FIG. 1, the DC-to-DC converter 102 may comprise a “module.” The term module is meant to refer to a pre-packaged electronic unit that performs a function. The module 102, for example, may comprise a mechanical housing that contains various electrical components coupled together to convert an incoming DC voltage to an output DC voltage. The converter's housing may be sealed to prevent contamination from effecting the components contained therein. By including the output adjust circuit 106 and providing a mechanism by which to influence the sense voltage from the load (i.e., the offset inject current), the output adjust circuit may be usable to control the output voltage of the converter module 102. The output adjust circuit 106 thus may be usable in conjunction with virtually any DC-to-DC converter module. The embodiment shown in FIG. 1 avoids the necessity of a custom circuit to connect to the TRIM input terminal of the converter 102.

FIG. 2 shows an exemplary implementation of the output adjust circuit 106. As shown, the circuit 106 may include resistors R1-R5 and an operational amplifier (op amp) 110 configured as a non-inverting amplifier. The S+ sense voltage from the load 104 may be connected to resistor R1. Resistors R1 and R4 may be connected in series with node 115 connected to the non-inverting input terminal (+) 112 of the op amp 110. As such, resistors R1 and R4 may form a voltage divider network in which the voltage at node 115 may be approximately equal to the sense voltage (S+) times the ratio of resistor R4 to the sum of R1 and R4. That is,

$$Node115voltage = {S}^{+} ( \frac{R4}{R1 + R4} )$$

In some embodiments, resistors R1 and R4 may be the same, or approximately the same, value of resistance and, in that case, the node 115 voltage is approximately to one half of the load's sense voltage S+.

Resistors R2 and R5 may define the gain of the non-inverting amplifier generally to be:

$$Gain = \frac{R2 + R5}{R5}$$

In some embodiments resistors R2 and R5 may be selected to be equal or approximately equal. As such, the resulting gain of the amplifier will be approximately equal to 2. Moreover, with the voltage divider network of resistors R1 and R4 reducing the sense voltage by a factor of 2 (at node 115), and the amplifier circuit providing a gain of 2, all else being equal, the resulting output voltage from op amp 110 (which is provided to the S+ input of the converter module 102) may be approximately equal to the sense voltage from the load 104.

Through resistor R3, an offset inject DC current (or voltage) can be injected. This current results in the output signal (S+) from op amp 110 to change—a higher offset inject current results in a smaller output op amp output voltage. As such, the sense input (S+) to the converter 102 can be adjusted through the output adjust circuit as desired. This permits a system designer (or other person) to monitor the behavior of a load 104 and adjust the offset inject current to achieve the most desirable load behavior.

The offset inject current may be generated through any of a variety of mechanisms. FIG. 3 shows an electronic system 150 coupled to a digital-to-analog converter (DAC) 152. The DAC 152 may generate the offset inject signal based on information generated by, and received from, the electronic system 150. The electronic system 150 may comprise the load 104 or may comprise separate logic altogether. The electronic system 150 may comprise, for example, a computer system. A person may control a value in the electronic system 150 to correspond to a particular offset inject current. After observing the behavior of the load 104, the person may adjust the value in the electronic system. This action may comprise incrementing or decrementing the value or otherwise selecting a new value as desired. A digital signal 151 indicative of the user-selected value may be provided to the DAC 152. The DAC 152 may convert the input digital signal 151 to, an analog signal (i.e., the offset inject current). In other embodiments, a digital potentiometer may be used to generate the offset inject current.

The output adjust circuit 106 described herein can be used with a DC-to-DC converter module in any of numerous applications including, but not limited to computer systems, consumer electronics (e.g., DVD players, digital cameras, etc.) and, in general, any electrical system employing DC-to-DC converters. The output adjust circuit 106 may be usable to tune the output voltage from a DC-to-DC converter module without regard to any module or manufacturer-specific trim (or equivalent) application details. The circuit 106 thus permits considerable flexibility to the system designer.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a DC-to-DC converter;
a load coupled to and receiving an operating voltage from said DC-to-DC converter;
an output adjust circuit coupled to said DC-to-DC converter and said load, said output adjust circuit receiving a first voltage from said load, generating a second voltage indicative both of the first voltage and of an offset signal, and providing said second voltage to said DC-to-DC converter; and
said DC-to-DC converter controlling said operating voltage using said second voltage.

2. The system of claim 1, wherein said offset signal comprises a variable DC current or voltage provided to the output adjust circuit.

3. The system of claim 2 wherein said output adjust circuit comprises an amplifier and a plurality of resistors coupled to said amplifier, and said variable DC current is provided to an input terminal of said amplifier.

4. The system of claim 1 further comprising a circuit to generate said offset signal, said circuit selected from the group consisting of a digital-to-analog converter and a digital potentiometer.

5. The system of claim 1 further comprising a means for generating said offset signal.

6. An output adjust circuit usable with a DC-to-DC converter that provides operating voltage to a load, comprising:
an amplifier;
a first resistor coupled to said amplifier;
wherein a first resistor receives a first voltage from said load, and said amplifier generates a second voltage indicative both of the first voltage and of an offset signal provided to a first input terminal of the amplifier, and the amplifier generates a second voltage provided to said DC-to-DC converter; and
wherein said second voltage causes the DC-to-DC converter to adjust the operating voltage provided to the load based on the second voltage.

7. The output adjust circuit of claim 6 further including a voltage divider coupled to a second input terminal of the amplifier.

8. The output adjust circuit of claim 6 wherein said voltage divider divides the first voltage approximately in half and the amplifier has a gain of approximately two.

9. A system, comprising:
a DC-to-DC converter;
a load coupled to and receiving an operating voltage from said DC-to-DC converter;
a means for receiving a first voltage from said load, generating a second voltage indicative both of the first voltage and of an offset signal, and providing said second voltage to said DC-to-DC converter; and
said DC-to-DC converter controlling said operating voltage using said second voltage.

10. The system of claim 9, wherein said offset signal comprises a variable DC current.

11. The system of claim 9 further comprising a means for generating said offset signal.

12. A method of controlling an operating voltage for a load comprising:
sensing a first voltage at the load;
generating a second voltage indicative of the first voltage and of an offset signal; and
providing said second voltage to a DC-to-DC converter; and
controlling said operating voltage based on an input power source and the second voltage.

13. The method of claim 12 further comprising converting a digital value to an analog signal corresponding to said offset signal.

14. The method of claim 13 wherein said analog signal is said offset signal.

15. A system, comprising:
a DC-to-DC converter module containing electronics contained within a sealed housing;
a load coupled to and receiving an operating voltage from said DC-to-DC converter module;
an output adjust circuit separate from and coupled to said DC-to-DC converter module and said load, said output adjust circuit receiving a first voltage from said load, generating a second voltage indicative both of the first voltage and of an offset signal, and providing said second voltage to said DC-to-DC converter module; and
said DC-to-DC converter module controlling said operating voltage based on an input voltage source and said second voltage from said output adjust circuit.

16. The system of claim 15, wherein said offset signal comprises a variable DC current provided to the output adjust circuit.

17. The system of claim 16 wherein said output adjust circuit comprises an amplifier and a plurality of resistors coupled to said amplifier, and said variable DC current is provided to an input terminal of said amplifier.

18. The system of claim 15 further comprising a circuit to generate said offset signal, said circuit selected from the group consisting of a digital-to-analog converter and a digital potentiometer.

19. The system of claim 15 further comprising a means for generating said offset signal.
